(19) United States
(12) Patent Application Publication
(10) Pub. No.: US 2019/0306102 A1
(43) Pub. Date: Oct. 3, 2019

(54) REMINDING METHOD OF UNFAMILIAR EMAILS

(71) Applicant: Cellopoint International Corporation, New Taipei City (TW)

(72) Inventors: Che-Jung Wu, New Taipei City (TW); Hong-Jhou Cian, New Taipei City (TW); Yu-Kang Wu, New Taipei City (TW)

(21) Appl. No.: 16/369,418

(22) Filed: Mar. 29, 2019

(30) Foreign Application Priority Data
Mar. 29, 2018 (TW) 107111076

(51) Int. Cl. H04L 12/58; H04L 29/06

(52) U.S. Cl. CPC H04L 51/22; H04L 63/1483; H04L 51/18; H04L 51/12

(57) ABSTRACT

A reminding method of unfamiliar emails includes: establishing a familiar database, the familiar database including familiar mail addresses and corresponding history records; receiving an email; verifying whether a sender address of the email is in the familiar database; generating a strange reminding message to a recipient of the email while the sender address is not in the familiar database; and determining whether the email is abnormal based upon the corresponding history records in the familiar database while the sender address is in the familiar database, and sending an abnormal reminding message to the recipient while the email is determined abnormal.

### CROSS-REFERENCE TO RELATED APPLICATION

This non-provisional application claims priority under 35 U.S.C. § 119(a) to Patent Application No. 107111076 filed in Taiwan, R.O.C. on Mar. 29, 2018, the entire contents of which are hereby incorporated by reference.

### BACKGROUND

### Technical Field

The instant disclosure relates to a reminding method of emails and, more particularly, to a reminding method of unfamiliar emails.

### Related Art

In the times of networks having been developed, malicious attacks such as viruses and junk mails can be done by emails. However, some attacks cannot be protected by means of virus protection and junk mail protection. For example, scam emails can be delivered by fake email addresses or altered email addresses pretending that they came from familiar contacts.

### SUMMARY

To address the above issue, the instant disclosure provides an embodiment of a reminding method of unfamiliar emails comprising: establishing a familiar database, the familiar database comprising a plurality of familiar mail addresses and a plurality of corresponding history records; receiving an email; verifying whether a sender address of the email is in the familiar database; generating a strange reminding message to a recipient of the email while the sender address is not in the familiar database; and determining whether the email is abnormal based upon the corresponding history records in the familiar database while the sender address is in the familiar database, and sending an abnormal reminding message to the recipient while the email is determined abnormal.

As a result, an unfamiliar email can be detected by inspecting a sender address of an email to increase alertness of a recipient in regard to the unfamiliar email.

### BRIEF DESCRIPTION OF THE DRAWINGS

FIG. 1 illustrates a schematic diagram of a network architecture of a mail gateway according to a first embodiment of the instant disclosure;

FIG. 2 illustrates a schematic diagram of a strange reminding message of an unfamiliar email according to the first embodiment of the instant disclosure;

FIG. 3 illustrates a schematic diagram of an architecture of the mail gateway according to the first embodiment of the instant disclosure;

FIG. 4 illustrates a flow chart of a reminding method of an unfamiliar email according to the first embodiment of the instant disclosure;

FIG. 5 illustrates a flow chart of a reminding method of an unfamiliar email according to a second embodiment of the instant disclosure;

FIG. 6 illustrates a schematic diagram of an abnormal reminding message of an unfamiliar email according to the first embodiment of the instant disclosure;

FIG. 7 illustrates a flow chart of a reminding method of an unfamiliar email according to a third embodiment of the instant disclosure;

FIG. 8 illustrates a schematic diagram of an architecture of a mail gateway according to a fourth embodiment of the instant disclosure; and

FIG. 9 illustrates a flow chart of a reminding method of an unfamiliar email according to the fourth embodiment of the instant disclosure.

### DETAILED DESCRIPTION

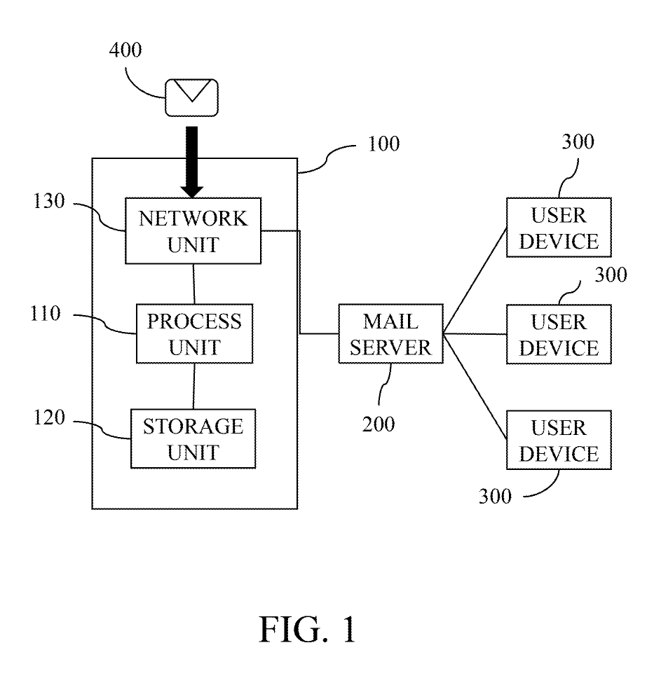

Referring to FIG. 1, which is a schematic diagram of a network architecture of a mail gateway 100 according to a first embodiment of the instant disclosure. The mail gateway 100 can be practiced in one or more computing devices. The computing device can be a computer or a server. The mail gateway 100 comprises a process unit 110, a storage unit 120, and a network unit 130. The process unit 110 is coupled to the storage unit 120 and the network unit 130. The process unit 110 can be a processor capable of computing and executing program codes. The storage unit 120 can be a non-volatile computer readable storage medium such as a hard drive, a solid-state drive, and a flash memory for storing program codes that the process unit can read and execute, so as to practice a reminding method of unfamiliar emails according to an embodiment of the instant disclosure. The network unit 130 provides a network interface to connect with the internet (not shown). Thus the mail gateway 100 can receive emails 400 via the internet. The mail gateway 100 and a mail server 200 can be connected to each other via a local area network or the internet. After the mail gateway 100 receives the email 400, the mail gateway 100 can inspect the email 400 to determine whether the email 400 is an unfamiliar email and deliver the inspected email 400 to the mail server 200, such that a user device 300 can receive the email 400 from the mail server 200. If the email 400 is an unfamiliar email, the mail gateway 100 will generate a reminding message 430 to remind the user. According to the content of the reminding message 430, it can be divided into a strange reminding message 431 and an abnormal reminding message 432, which will be described below.

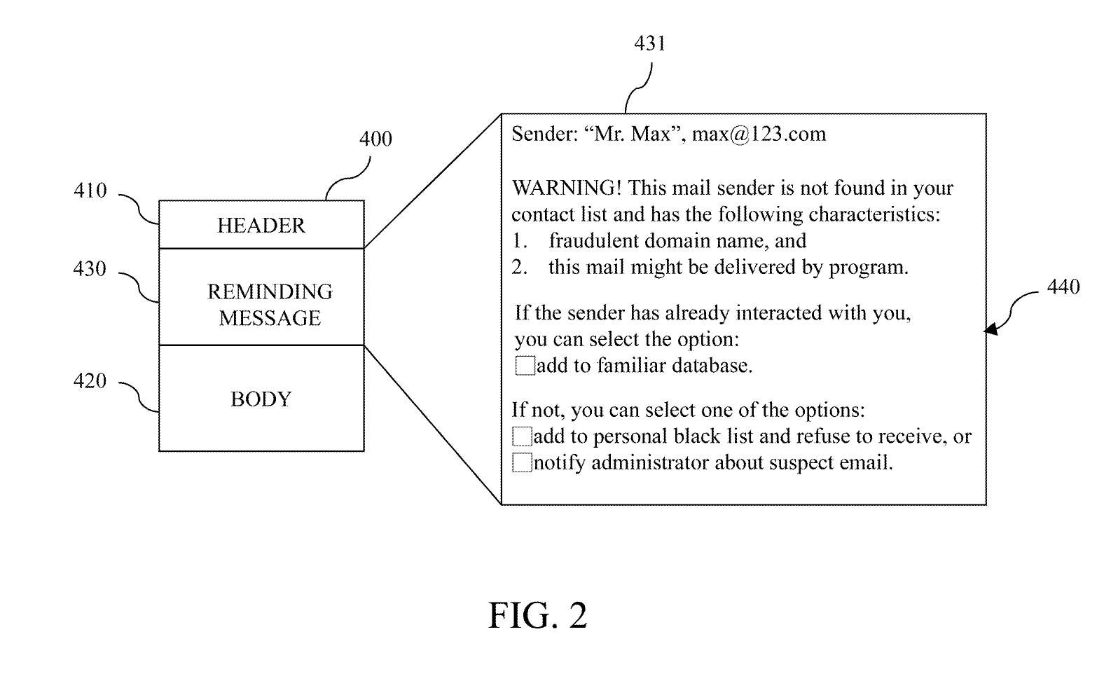

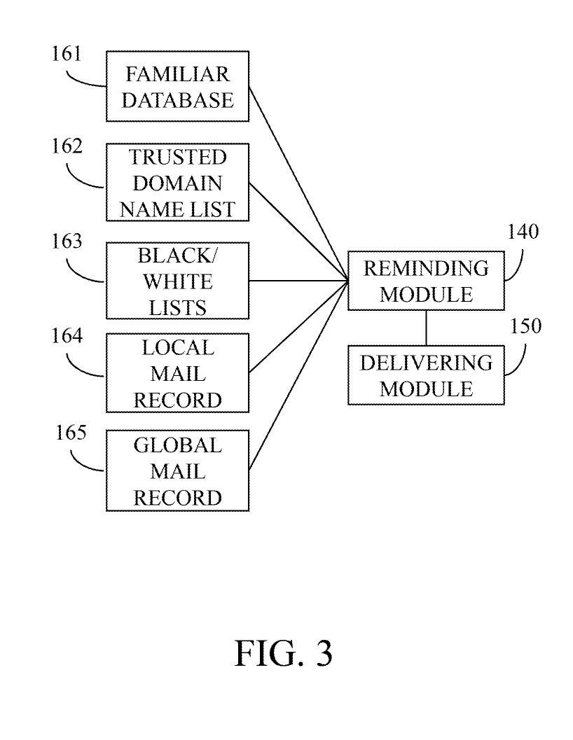

Referring to FIG. 2, which is a schematic diagram of a strange reminding message of an unfamiliar email according to the first embodiment of the instant disclosure. The email 400 comprises an envelope and a content (not shown). The content comprises a header 410 and a body 420. In the example, the email 400 is deemed as an unfamiliar email. The reminding message 430 (the strange reminding message 431 in the example) is inserted into the email 400. While the user receives the email 400, the user can read both of the reminding message 430 and the content. While the user read the reminding message 430, the user can determine whether to pay attention to the email 400. The reminding message 430 can also comprise an interactive option 440. As shown in FIG. 2, if an option of “add to familiar database” is selected, the email address of the sender (referred to “the sender address”) is added to a familiar database 161 (as shown in FIG. 3) of the user (i.e., the recipient). If an option of “add to personal black list and refuse to receive” is selected, the sender address may be added to a black list of the user (i.e., the recipient). After that, while the mail gateway 100 receives other emails of the same sender address, the emails will be blocked, and the user will not receive the emails sent from the same sender. If the user has another question, the user can select an option of “notify administrator about suspect email.” In the example, the sender address comprises a domain name and a user name. As shown in FIG. 2, the domain name is “123.com,” and the user name is “max.” A displayed name of the sender of the email 400 (referred to “the sender name”) is “Mr. Max.”

In some embodiment, there is another way to remind the user. For example, although the email 400 is deemed as an unfamiliar email, the mail gateway 100 may still deliver the original email 400 to the mail server 200, such that the user can receive the email 400. However, after the email 400 is delivered, another email containing the reminding message 430 as shown in FIG. 2 is further delivered to the user (i.e., the recipient).

In some embodiments, if the email 400 is deemed as an unfamiliar email, the email 400 is not delivered to the mail server 200 instantly, i.e., the email 400 is quarantined. The mail gateway 100 delivers another email containing the reminding message 430 as shown in FIG. 2 to the user (i.e., the recipient) in advance. In the example, the reminding message 430 further comprises an option of “release mail.” While the user selects the option of “release mail,” the mail gateway 100 delivers the original email 400 to the mail server 200.

In some embodiments, the reminding message 430 further carries an attachment. The attachment can be a conversion file of the original email 400 (e.g., a PDF file or an image file) to lower the risk of intrusion of viruses or malicious software. While the user selects the option of “release mail” of the reminding message 430, the mail gateway 100 delivers the original email 400 to the mail server 200.

In some embodiments, the reminding message 430 comprises a link of a web address. While the user clicks the link, a web page can be connected to, and the user can survey the content of the original email 400 on the web page online. The risk of intrusion of viruses or malicious software can be lowered. While the user confirms that the content has no risk, the user can select the option of “release mail” of the reminding message 430, such that the mail gateway 100 can deliver the original email 400 to the mail server 200.

Referring to FIG. 3, which is a schematic diagram of an architecture of the mail gateway 100 according to the first embodiment of the instant disclosure. Multiple function modules, e.g., a reminding module 140 and a delivering module 150, can be practiced by the process unit 110 executing the program codes stored in the storage unit 120. The delivering module 150 can deliver the email 400 to the mail server 200. The storage unit 120 can store data of the familiar database 161, a trusted domain name list 162, black/white lists 163, a local mail record 164, and a global mail record 165. The function of the function modules and the data will be described with flow charts below.

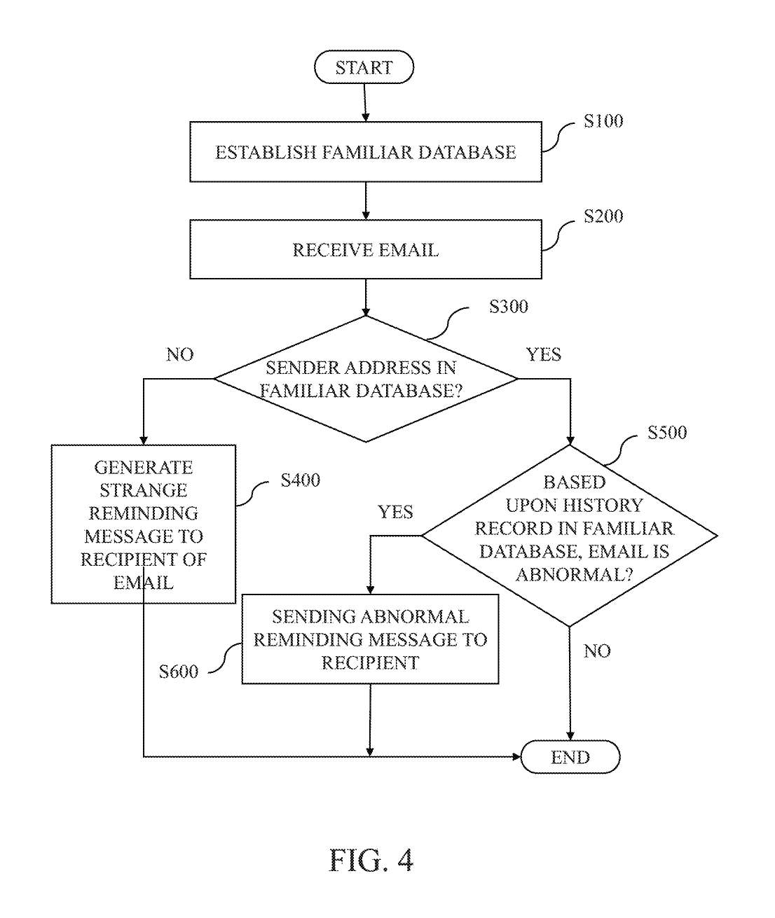

Referring to FIG. 4, which is a flow chart of a reminding method of an unfamiliar email according to the first embodiment of the instant disclosure. In step S100, the reminding module 140 establishes the familiar database 161. The familiar database 161 records mail addresses trusted by the user (referred to “the familiar mail address”). In some embodiments, the familiar database 161 can be established by using a screen condition to catch mail addresses in a past mail record of the user (i.e., the local mail record 164). For example, a sender address from which mails have been delivered to the user and to which mails have been sent by the user over a specific times can be caught, or a sender address have been interacted with the user over a specific value of frequency can be caught. In some embodiments, the reminding module 140 may provide an input page for inputting a familiar mail address by the user. In addition, the familiar database 161 further records history record corresponding to respective familiar mail addresses. The history record may contain commonly used sender names, commonly used IP (internet protocol) addresses, and frequently sending time of senders.

As shown in FIG. 4, while the email 400 is received (step S200), the reminding module 140 will determine whether the sender address of the email 400 is in the familiar database 161 in step S300. In other words, the reminding module 140 will check if there is a familiar mail address recorded in the familiar database 161 the same as the sender address of the email 400. “The same” means that the domain name and the user name of one of the familiar mail addresses in the familiar database 161 are respectively the same as the domain name and the user name of the sender address of the email 400.

As shown in FIG. 4, if the same sender address does not exist in the familiar database 161, the reminding module 140 will generate the strange reminding message 431 delivered to the recipient of the email 400 via the delivering module 150 (step S400) to remind the recipient that the email 400 is sent from an unknown person and thus requires an additional attention.

As shown in FIG. 4, if the sender address exists in the familiar database 161, it means that the sender address belongs to a familiar person. Although the sender address belongs to a familiar person, it is still possible of misappropriation or fraudulent use (i.e., the sender name is altered to another name). The reminding module 140 will determine whether the email is abnormal according to corresponding history record in the familiar database 161 (step S500). If it is abnormal, the delivering module 150 delivers the abnormal reminding message 432 to the recipient (step S600). Otherwise, the abnormal reminding message 432 is not delivered.

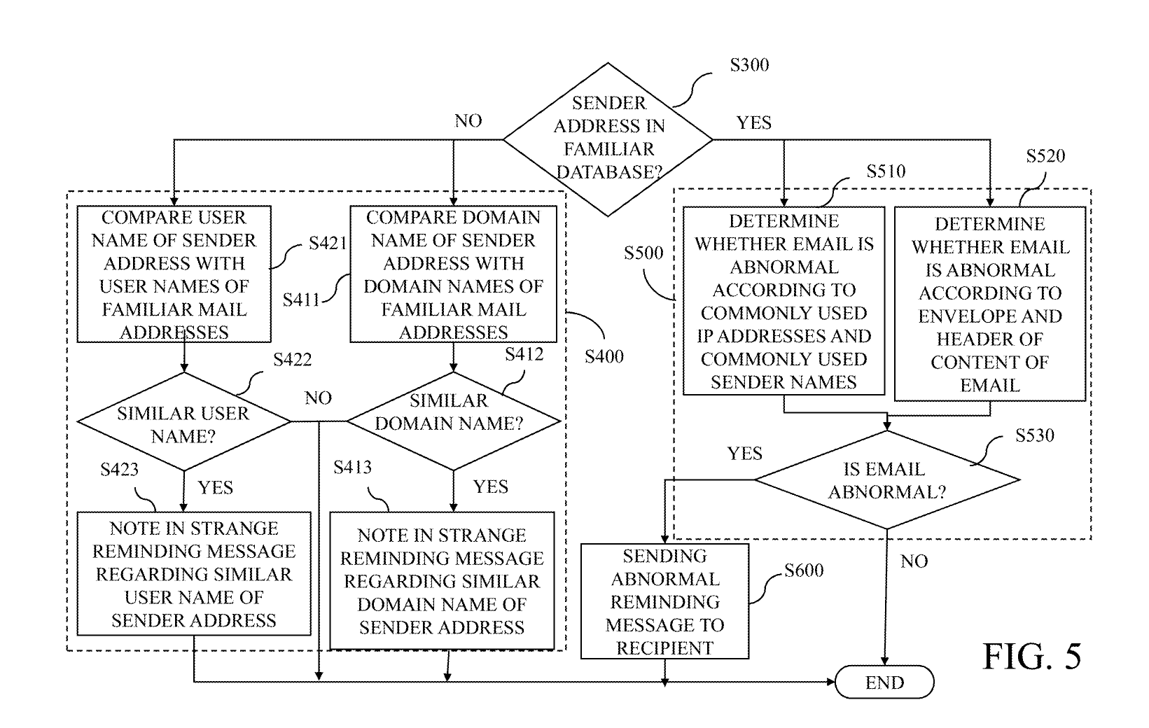

Referring to FIG. 5, which is a flow chart of a reminding method of an unfamiliar email according to a second embodiment of the instant disclosure. In the aforementioned step S500, the way to determine whether the email 400 is abnormal can be performed by step S510 and/or step S520.

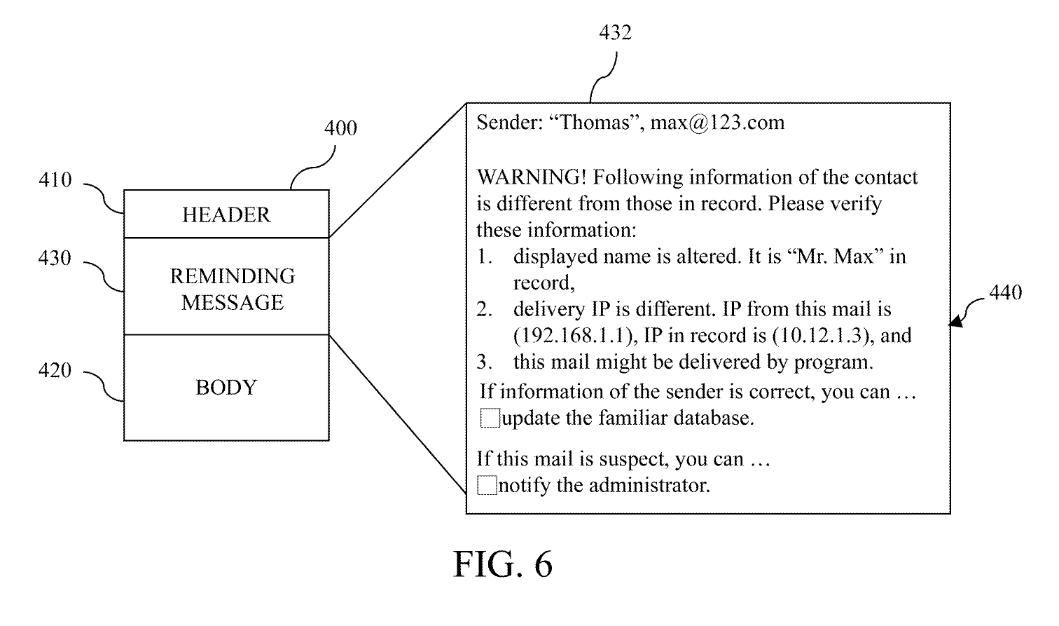

The step S510 is: to determine whether the email 400 is abnormal according to the commonly used IP addresses and the commonly used sender names in the history record. If the email 400 is delivered due to a misappropriated mail box, the IP address for delivering the email 400 will be different from the commonly used IP address in the history record. Hence, comparing the IP address for delivering the email 400 with the commonly used IP address of the sender address in the history record can be one of bases to determine whether the email 400 is abnormal. That is to say, if the comparison results in the same, the probability of abnormal may be lower; if the comparison results in difference, the probability of abnormal may be higher. Thus, if the IP addresses are different, the reminding module 140 will note in the abnormal reminding message 432 regarding the IP address of the email 400 being different from those in the history record (as shown in FIG. 6) to remind the recipient. If the sender alters the sender name to a fraudulent name intentionally to assume other's name, the reminding module 140 will find out that the sender name is different from those in the history record and therefore note in the abnormal reminding message 432 regarding the displayed name being altered (as shown in FIG. 6).

The step S520 is: to determine whether the email 400 is abnormal according to consistence or inconsistence of the envelope of the email 400 and the header 410 of the content of the email 400. The envelope of the email 400 contains two SMTP (Simple Mail Transfer Protocol) commands of “MAIL FROM” and “RCPT TO.” The header 410 of the email 400 contains “From,” “To,” “Subject,” and “Date.” The email 400 automatically delivered by program usually has the envelope being inconsistence with the header 410. Thus the email 400 can be determined if it is abnormal (i.e., being delivered automatically by program) by comparing the envelope and the header 410 to check whether they are consistence. The way of comparison can be practiced by SPF (Sender Policy Framework), DMARC (Domain-based Message Authentication, Reporting & Conformance), or DKIM (DomainKeys Identified Mail). As a result, in the step S600, the abnormal reminding message 432 is noted with “this mail might be delivered by program” (as shown in FIG. 6).

If there is a determination of abnormal in any one of the step S510 or the step S520, it can be determined that the email 400 is abnormal. In contrast, if there is no determination of abnormal, it can be determined that the email 400 is normal (step S530).

As shown in FIG. 5, in the aforementioned step S500, there are step S411 and/or step S421 which can be executed respectively to further determine what kind of the abnormality of the email 400 is. In the example, the steps before the step S300 can be referred to the first embodiment, and there is no need to go into details.

The step S411 is: to compare the domain name of the sender address with the domain names of the familiar mail addresses; and then, to determine whether the domain name of the sender address is similar with one of the domain names of the familiar mail addresses (step S412). If there is a similar domain name, it is possible that the sender has intent to assume other's name by using the similar domain name. Hence, the reminding module 140 will note in the strange reminding message 431 regarding the domain name of the sender address being similar with one of the domain names of the familiar mail addresses (step S413) to remind the recipient (“fraudulent domain name” as shown in FIG. 2).

The step S421 is: to compare the user name of the sender address with the user names of the familiar mail addresses; and then, to determine whether the user name of the sender address is similar with one of the user names of the familiar mail addresses (step S422). If there is a similar user name, it is possible that the sender has intent to assume other's name by using the similar user name. Hence, the reminding module 140 will note in the strange reminding message 431 regarding the user name of the sender address being similar with one of the user names of the familiar mail addresses (step S423) to remind the recipient.

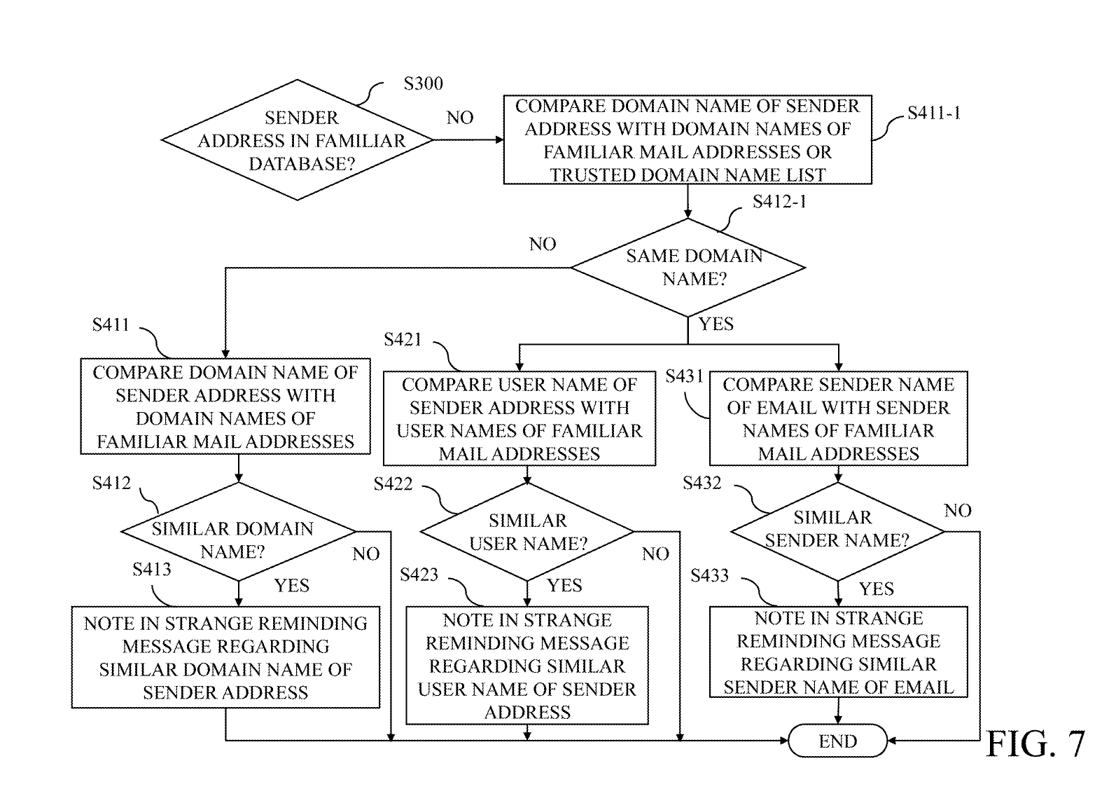

Referring to FIG. 7, which is a flow chart of a reminding method of an unfamiliar email according to a third embodiment of the instant disclosure. In the example, the steps before the step S300 can be referred to the first embodiment, and while the determination of the step S300 is “Yes,” subsequent steps can be referred to the second embodiment; therefore, there is no need to go into details. In the third embodiment, while the determination of the step S300 is “No,” subsequent steps comprises step S411-1 and step S412-1.

In the step S411-1, the domain name of the sender address is compared with the domain names of the familiar mail addresses (i.e., the above step S411), or the domain name of the sender address is compared with the trusted domain name list (i.e., determining whether the domain name of the sender address is listed in the trusted domain name list). In some embodiments, the domain name of the sender address can be compared with the domain names of the familiar mail addresses and can also be compared with the trusted domain name list. The trusted domain name list 162 records domain names which can be trusted. For instance, domain names of mail boxes provided by famous internet server provider and domain names of mail boxes of companies. Thereby, while the domain name of the sender address is different from any one of the domain names recorded in the trusted domain name list 162, it means that the domain name of the email 400 might be newly applied, and there is a possibility that the domain name may be used in fraud.

In the step S412-1, if any one of the comparisons results in the same, the steps of the comparison of the user names of the email 400 (step S421) and/or the comparison of the sender name of the email 400 (step S431) can be further executed.

In the step S421 and the step S422, if the domain name of the sender address is the same as one of the domain names of the familiar mail addresses, the user names of the familiar mail addresses with the same domain name are further compared with the user name of the email 400 to determine whether there is a user name of the familiar mail addresses similar to the user name of the email 400. If the domain name of the sender address is in the trusted domain name list, the user name of the email 400 is further compared with the user names of the familiar mail addresses with the same domain name to determine whether there is a user name of the familiar mail addresses similar to the user name of the email 400. If there is a similar user name in the familiar mail addresses, it is possible that the sender has intent to assume other's name by using the similar user name. Hence, the reminding module 140 will note in the strange reminding message 431 regarding the user name of the email 400 being similar with one of the user names of the familiar mail addresses (step S423) to remind the recipient.

In the step S431 and the step S432, if the domain name of the sender address is the same as one of the domain names of the familiar mail addresses, the sender names of the familiar mail addresses with the same domain name are further compared with the sender name of the email 400 to determine whether there is a sender name of the familiar mail addresses similar to the sender name of the email 400. If the domain name of the sender address is in the trusted domain name list, the sender name of the email 400 is further compared with the sender names of the familiar mail addresses with the same domain name to determine whether there is a sender name of the familiar mail addresses similar to the sender name of the email 400. If there is a similar sender name in the familiar mail addresses, it is possible that the sender has intent to assume other's name by using the similar sender name. Hence, the reminding module 140 will note in the strange reminding message 431 regarding the sender name of the email 400 being similar with one of the sender names of the familiar mail addresses (step S433) to remind the recipient.

If the comparison in the step S412-1 results in that the domain name of the sender address is different from all of the domain names of the familiar mail addresses and the domain names in the trusted domain name list, the steps S411 to S413 are executed to determine whether the sender has intent to assume other's domain name by using the domain name.

In the example, the steps S300, S411, S412, and S413 are the same as those of the second embodiment, and there is no need to go into details.

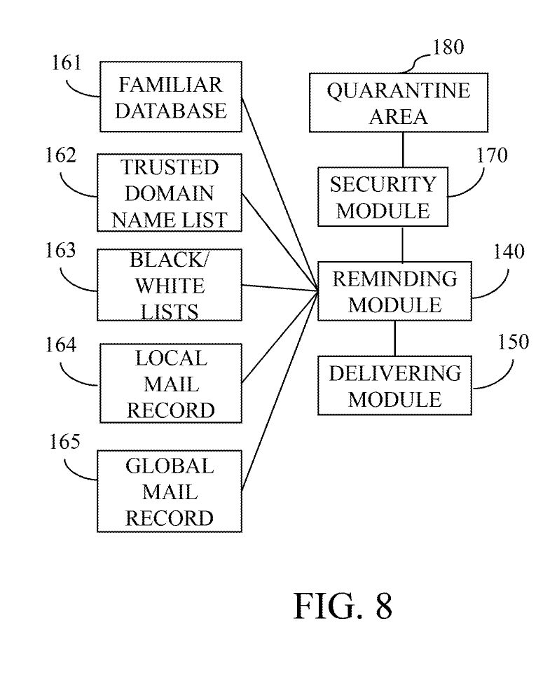

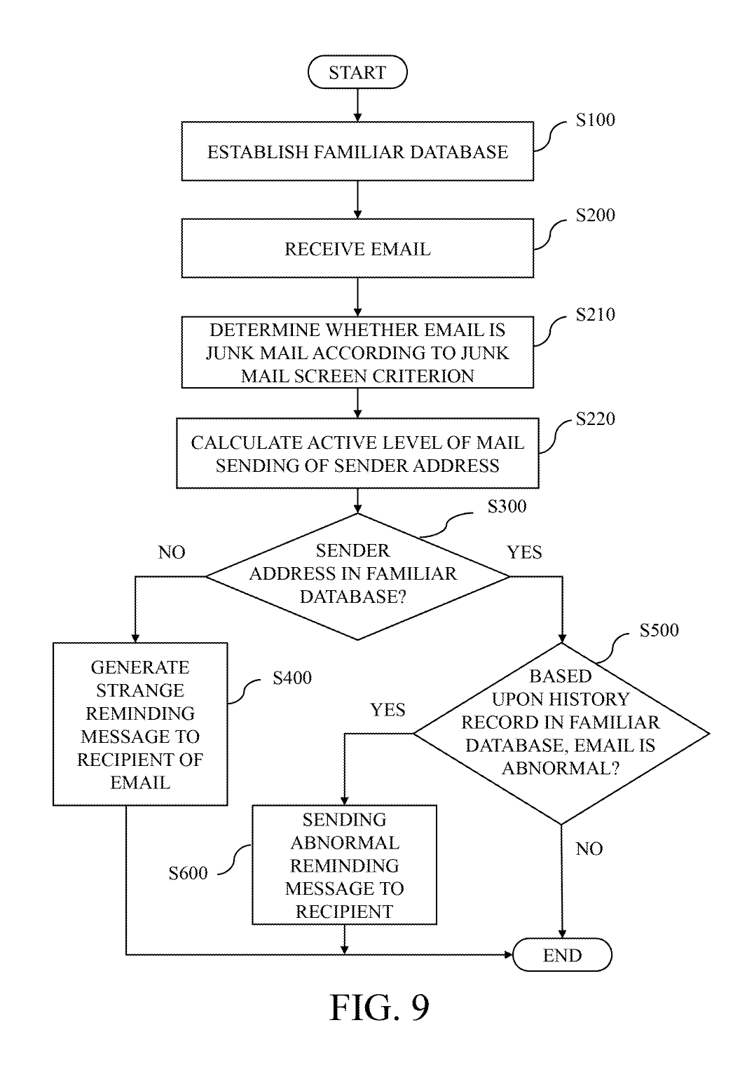

Referring to FIG. 8 and FIG. 9, which are respectively a schematic diagram of an architecture of a mail gateway and a flow chart of a reminding method of an unfamiliar email according to a fourth embodiment of the instant disclosure. Differences of the embodiment different from the aforementioned embodiments are: the function modules of the mail gateway 100 further comprises a security module 170 and a quarantine area 180; and step S210 can be executed ahead of the step S300.

As shown in FIG. 8, the security module 170 can provide functions such as virus protection and junk mail filter and can quarantine mails which need to be quarantined in the quarantine area 180. As shown in FIG. 9, the step S210 is to determine whether the email 400 is junk mail according to a junk mail screen criterion. If the email 400 is not junk mail, the step S300 is executed, and followed by the aforementioned subsequent steps. In other words, the embodiments of the instant disclosure can provide protections better than virus protection and junk mail protection and can detect unfamiliar email which has no virus to be detected but is screened by the junk mail screen criterion. As a result, the embodiments of the instant disclosure can remind the recipient in time.

In some embodiments, while the sender address is determined that it is not the same as any one of the sender addresses in the familiar database 161 in the step S300, a step of determining whether one or more preset conditions are satisfied can be executed in advance. In a case that the preset conditions are not satisfied, the aforementioned subsequent steps for inspection following the step S300 need to be executed. In contrast, in a case that the preset conditions are satisfied, the sender address is added into the familiar database 161, and the aforementioned subsequent steps for inspection following the step S300 need not to be executed. For instance, the preset condition may be: determining whether the sender address is in the black/white list 163. If the sender address is in the white list, it means that the sender address is a verified, safe mail address; therefore, the sender address is added into the familiar database 161, and the aforementioned subsequent steps for inspection following the step S300 need not to be executed. In contrast, if the sender address is in the black list, the aforementioned subsequent steps for inspection following the step S300 need to be executed. For instance, the preset condition may also be: checking whether the sender address is verified by other users based upon the familiar database 161 of other users. If the sender address is verified by other users, the sender address is then added into the familiar database 161, and the aforementioned subsequent steps for inspection following the step S300 need not to be executed. In contrast, if the sender address is not verified by other users, the aforementioned subsequent steps for inspection following the step S300 need to be executed. The preset condition may also be: checking whether the user has ever sent mail to the sender address. If yes, the sender address is then added into the familiar database 161, and the aforementioned subsequent steps for inspection following the step S300 need not to be executed. In contrast, if no, the aforementioned subsequent steps for inspection following the step S300 need to be executed. The number of mails needing to be inspected and time for inspection can be less based upon these preset conditions.

In some embodiments, as shown in FIG. 9, the reminding method of unfamiliar email can further comprise step S220, which is to calculate an active level of mail sending of the sender address. In the embodiment, the step S220 is, but not limited to, executed after the step S210 and before the step S300. In some embodiments, the step S220 can be executed along with the steps S300-S600, be executed after the steps S300-S600, or be executed after receiving the email (the step S200).

In the step S220, the active level can be calculated based upon multiple parameters or one of the parameters. The parameters may be, for example, a frequency of mail sending of the sender address or the number of the sent mails. The parameters can be obtained based upon the local mail record 164 and/or the global mail record 165. The global mail record represents historical mail records of multiple mail addresses of recipients (users) with the same domain name. That is to say, in some embodiments, the parameters can be relative to the sender in the historical mail record of a single recipient. In some embodiments, the parameters can be relative to the same sender in the historical mail record of multiple recipients.

The active level of mail sending can be classified into multiple levels such as high active level, medium active level, and low active level. The lower the active level is, the higher possibility that the sender is unfamiliar to the recipient is. After the active level of mail sending is calculated, the reminding module 140 will note in the strange reminding message 431 regarding the calculated active level of mail sending.

Based upon at least one of the above embodiments, the domain name and the user name of the sender address of the email 400 and the sender name and/or the active level of mail sending can be inspected to increase alertness of the recipient in regard to unfamiliar emails.

What is claimed is:

1. A reminding method of unfamiliar emails, comprising:
establishing a familiar database, the familiar database comprising a plurality of familiar mail addresses and a plurality of corresponding history records;
receiving an email;
verifying whether a sender address of the email is in the familiar database;
generating a strange reminding message to a recipient of the email while the sender address is not in the familiar database; and
determining whether the email is abnormal based upon the corresponding history records in the familiar database while the sender address is in the familiar database, and sending an abnormal reminding message to the recipient while the email is determined abnormal.

2. The reminding method of unfamiliar emails of claim 1, wherein the determining whether the email is abnormal based upon the corresponding history records in the familiar database is based upon commonly used internet protocol addresses or commonly used sender names in the history records.

3. The reminding method of unfamiliar emails of claim 1, wherein while the sender address is in the familiar database, the reminding method further comprises:
determining whether the email is abnormal based upon consistence or inconsistence of an envelope of the email and a header of a content of the email.

4. The reminding method of unfamiliar emails of claim 1, wherein while the sender address is not in the familiar database, the reminding method further comprises:
comparing a domain name of the sender address with domain names of the familiar mail addresses; and
noting in the strange reminding message regarding the domain name of the sender address being similar while the domain name of the sender address is similar to one of the domain names of the familiar mail addresses.

5. The reminding method of unfamiliar emails of claim 1, wherein while the sender address is not in the familiar database, the reminding method further comprises:
comparing an user name of the sender address with user names of the familiar mail addresses; and
noting in the strange reminding message regarding the user name of the sender address being similar while the user name of the sender address is similar to one of the user names of the familiar mail addresses.

6. The reminding method of unfamiliar emails of claim 1, wherein while the sender address is not in the familiar database, the reminding method further comprises:
comparing a domain name of the sender address with domain names of the familiar mail addresses;
comparing a sender name of the email with sender names of the familiar mail addresses while the domain name of the sender address is the same as one of the domain names of the familiar mail addresses; and
noting in the strange reminding message regarding the sender name of the email being similar while the sender name of the email is similar to one of the sender names of the history records.

7. The reminding method of unfamiliar emails of claim 6, wherein while the sender address is not in the familiar database, and the domain name of the sender address is the same as one of the domain names of the familiar mail addresses, the reminding method further comprises:
comparing an user name of the sender address with user names of the familiar mail addresses; and
noting in the strange reminding message regarding the user name of the sender address being similar while the user name of the sender address is similar to one of the user names of the familiar mail addresses.

8. The reminding method of unfamiliar emails of claim 6, wherein while the sender address is not in the familiar database, the reminding method further comprises:
verifying whether the domain name of the sender address is in a trusted domain name list;
if not, comparing the domain name of the sender address with the domain names of the familiar mail addresses; and
noting in the strange reminding message regarding the domain name of the sender address being similar while the domain name of the sender address is similar to one of the domain names of the familiar mail addresses.

9. The reminding method of unfamiliar emails of claim 1, further comprising:
calculating an active level of mail sending of the sender address and noting the active level in the strange reminding message.

10. The reminding method of unfamiliar emails of claim 1, wherein before verifying whether the sender address of the email is in the familiar database, the reminding method further comprises:
determining whether the email is junk mail based upon a junk mail screen criterion.
